(19) United States
(12) Patent Application Publication
(10) Pub. No.: US 2026/0369176 A1
(43) Pub. Date: Nov. 19, 2026

(54) REAL-TIME TEACHING AND LEARNING PLATFORM USING MACHINE LEARNING AND ARTIFICIAL INTELLIGENCE

(71) Applicants: Rajesh KUMAR, Billerica, MA (US); Jyotishree ROUTRAY, Billerica, MA (US)

(72) Inventors: Rajesh KUMAR, Billerica, MA (US); Jyotishree ROUTRAY, Billerica, MA (US)

(21) Appl. No.: 18/668,213

(22) Filed: May 19, 2024

(51) Int. Cl. G09B 7/00; G06Q 50/20

(52) U.S. Cl. CPC G09B 7/00; G06Q 50/205

(57) ABSTRACT

A comprehensive teaching and learning educational platform that utilizes Machine Learning (ML) and Artificial Intelligence (AI) to facilitate the understanding and teaching of a wide array of subjects, including academic disciplines and professional skill development, emphasizing personalized and adaptive learning. The invention introduces real-time adaptation not just for content difficulty but also for teaching methods and materials, ensuring a profoundly personalized and versatile learning journey. It dynamically generates content tailored precisely to each student's unique comprehension levels, and learning preferences by adjusting the complexity of the content based on the student's comprehension, providing options for simpler or more detailed explanations. Moreover, the platform extends its utility beyond mere content delivery, it transcends the traditional boundaries of problem-solving within these subjects by offering a diverse array of approaches.

### FIELD OF THE INVENTION

The invention relates to the field of educational platform, specifically utilizing machine learning (ML) and artificial intelligence (AI) to personalize and adapt the learning experience in physics, mathematics, and other subjects.

### BACKGROUND

Complex subjects such as physics and mathematics have long been regarded as foundational subjects that form the bedrock of scientific and mathematical understanding and are characterized by intricate concepts, abstract theories, and often non-intuitive principles. However, the very attributes that make these subjects so powerful—namely, their depth, complexity, and abstract nature—also make them challenging to teach and learn. Students come to these subjects with a wide range of cognitive profiles, learning styles, and prior knowledge. Some students may have a natural aptitude for mathematical reasoning, while others may find it challenging. Similarly, physics can be both fascinating and discouraging depending on one's level of exposure and understanding of fundamental concepts.

Given this diversity in student backgrounds and cognitive profiles, traditional one-size-fits-all pedagogical approaches often fall short. A standardized curriculum and teaching methods can leave many students behind, failing to engage them effectively with the subject matter. Hence, there is a compelling need for a more adaptive and personalized approach to teaching physics and mathematics.

An adaptive and personalized pedagogical approach, supported by ML and AI, can address these challenges. Such an approach can tailor educational content to match individual student comprehension levels, learning styles, and preferences, ensuring that each student can unlock their full intellectual potential in the fields of physics and mathematics.

FIG. 1 illustrates prior-art adaptive teaching platform 100. The platform 100 comprises of a content modification engine 103 directly connected to a network 105. The platform 100 further includes user 101, content server 102, one or more content sources 106, including first content source 106a, second content source 106b, . . . , and n^{th} content source 106n, and a database 104. Content sources 106, may correspond to an entity, whether an individual, a firm, or an organization, publishing or supplying content. User 101 may be different types of users such as those connected to network via wired or wireless connection such as laptops, phones, desktops, head mounted display etc. The content modification engine 103, provide the users with relevant content obtained from the content sources 106, and which is personalized based on a literacy level of the user. A user 101 requests content from a content server 102 or content modification engine 103. Both servers are directly connected to the network 105. The system obtains information about the user's literacy level and corresponding literacy score. The content modification engine 103 updates or modifies the content according to the user's literacy level, and then provides the updated content to the user in response to the query.

These traditional teaching system faces limitations in providing real-time personalized content generation and fails to cater to the individual learning trajectories of students, which hinders the full development of their intellectual abilities. In complex subjects such as physics and mathematics, conventional teaching approaches follow a linear curriculum that progresses from basic to advanced topics, without much consideration for the unique needs of each student. This approach can lead to several issues, such as student disengagement, missed opportunities, limited learning trajectories, and inequality. Students who find the material too easy may become bored and disengaged, while those who find it too difficult may become frustrated and discouraged. Some students may have untapped potential in these subjects but are unable to explore more advanced concepts due to rigid curricular structures. The linear approach may not accommodate the diverse learning trajectories of students, hindering their intellectual growth. It may exacerbate educational inequalities, as students with varying levels of prior knowledge may struggle to keep pace.

Also, the existing teaching and learning systems are not flexible enough to generate personalized content based on individual students' comprehension levels and learning preferences. Additionally, traditional models do not provide a variety of approaches to solve complex problems within the subjects or customization based on individual preferences. As a result, students may not receive optimal learning experiences.

### SUMMARY

The invention pertains to the domain of personalized teaching and learning platform, by harnessing the powers of ML and AI for tailoring educational experiences. It achieves this through a dynamic and adaptive approach to content delivery, characterized by personalized video lectures and storytelling modules. These materials are not static; rather, they are meticulously curated in real-time to align seamlessly with each student's unique comprehension level and learning predilections.

This platform offers a flexible approach to education, recognizing that comprehension levels can vary widely, even within the same subject. Multiple iterations of content are available, ranging from detailed explanations to simpler presentations that are easier to understand. Students can choose the content that best suits their current learning needs, giving them the autonomy to achieve their learning goals.

The educational platform introduces real-time adaptation of content based on student interactions. It doesn't simply rely on initial assessments but continuously adjusts the teaching approach as the student progresses. This dynamic adaptation ensures that learning remains effective throughout the entire educational journey, regardless of the student's initial proficiency level.

The platform operates on a deeply ingrained principle: every student's learning journey is unique and should be treated as such. It meticulously tracks and analyzes various aspects of student interaction, from real-time responses to engagement with quizzes and activities. These data points provide invaluable insights into each student's progress, highlighting areas of strength, weakness, and preferred learning approaches. What sets this platform apart is its unwavering commitment to personalized education. It doesn't just stop at tracking progress; it actively adapts to each student's needs in real time. For instance, if a student struggles with a particular concept, the platform adjusts its teaching style to accommodate this difficulty, ensuring that the student receives the support they need without feeling judged or stigmatized. This adaptability is crucial for fostering an inclusive learning environment where every student feels valued and supported. By tailoring educational materials to match each student's comprehension level and learning preferences, the platform empowers students to thrive at their own pace. Moreover, it does so seamlessly, transitioning back to standard teaching methods once a concept is mastered. In essence, the platform's central ethos revolves around prioritizing the individual learning journey of each student. It recognizes that learning is not a one-size-fits-all endeavor and strives to create an environment where every student feels encouraged to explore, grow, and succeed. Through its adaptive and supportive approach, the platform paves the way for a more inclusive and effective education system.

Moreover, the platform extends its utility beyond mere content delivery. It transcends the traditional boundaries of problem-solving within these subjects by offering a diverse array of approaches. Students can explore and master complex problems using mathematical formalism, intuitive physical principles, or other methods, depending on their individual preferences and cognitive styles.

The fusion of ML and AI with education heralds a new era of personalized, adaptable, and interactive learning. This teaching and learning platform are composed to transform education itself, empowering students of diverse backgrounds, ages, and abilities to navigate the complex worlds of physics, mathematics, and a myriad of other subjects with newfound confidence and competence. It is a beacon guiding us towards a future where knowledge knows no bounds, and the pursuit of learning is an ever-illuminating journey.

### BRIEF DESCRIPTION OF THE DRAWINGS:

FIG. 1 illustrates prior-art teaching model.

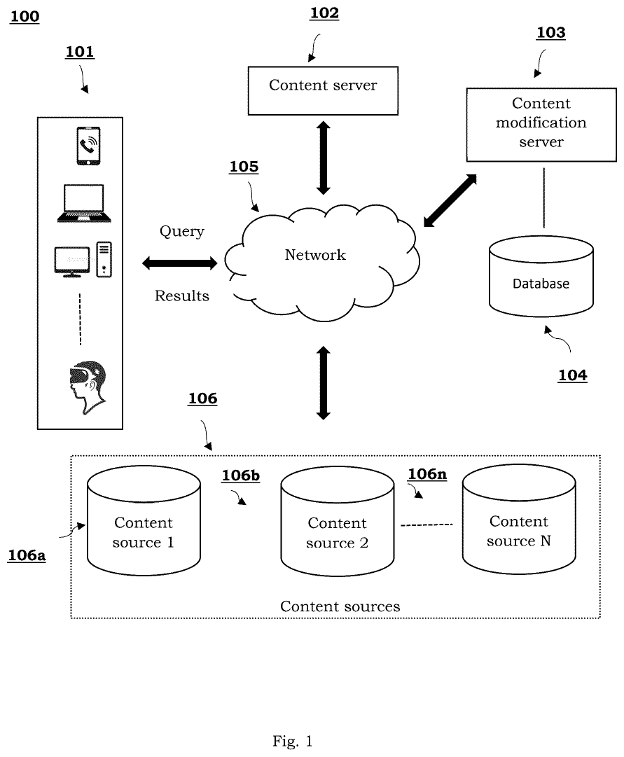

FIG. 2 illustrates a simplified diagram of an AI and ML based educational platform.

FIG. 3 illustrates a flowchart showing the steps involved in registering for the platform.

FIG. 4 is flow diagram that illustrates a problem-solving method for an adaptive educational platform.

### DETAILED DESCRIPTION

The following is a detailed description of exemplary embodiments to illustrate the principles of invention. The present disclosure can be embodied in many different forms and is not limited to any embodiment. In view of the many possible embodiments, it should be recognized that embodiments represented herein are shown with references accompanying the drawings and will herein be described in detail. The embodiments described herein are meant for illustrative purposes only.

The invention relates to the domain of adaptive and personalized teaching and learning system for providing education. By harnessing the computational power of AI and ML the system creates a symbiotic relationship with students, enabling them to receive tailored education that meets their unique needs and learning styles. This individualized approach fosters a deeper understanding of subjects, increased engagement and improved academic outcomes that maximizes their potential for success.

The core functionality of the system revolves around its ability to interact with the students on individual basis. It uses advanced AI algorithms to evaluate each student's competency in a particular subject. The platform creates unique video lectures and storytelling content dynamically based on real-time responses, progress, and learning patterns. This guarantees that every learner gets a customised learning environment that perfectly matches their present comprehension level and preferred methods of learning.

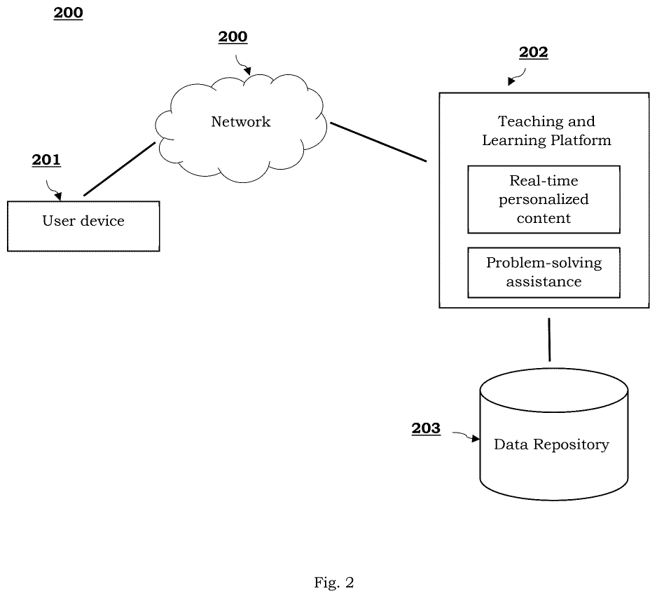

FIG. 2 illustrates an exemplary teaching and learning system for providing education using AI and ML. The system 200 comprises of a user device 101, AI and ML driven teaching and learning platform 102, a network 103, and a data repository 104.

The network 103 can be a single network or a combination of different networks. For example, the network may be a local area network (LAN), a wide area network (WAN), a public network, a private network, a Public Telephone Switched Network (PSTN), a wireless network, a cellular network, a virtual network, or any combination thereof.

A user device 101, is used to display a teaching and learning platform interface. It presents generated content in the form of visual and/or audio data. The platform is designed for effortless integration across various platforms, and it can work with different devices such as laptops, desktop computers, virtual reality (VR) environments, and holographic interfaces. This ensures that the learning experience aligns with the devices and modes of interaction that users prefer, allowing them to engage in their studies at their convenience.

The user interface is designed to enable learners to easily register and provide information about their preferred skill development areas, specific goals and chosen subject area. Through this interface, users can input their preferences and goals, which can then be used to personalize their learning experience and help them achieve their desired outcomes. The platform is user-friendly and intuitive, and provide guidance to the learners through the registration and input process.

The platform envisions a holistic approach to education, spanning diverse subjects such as physics, mathematics, chemistry, English, biology, economics, finance, accounts, management, dance, history, civics, geography, music, and more.

The platform is equipped with an extensive knowledge base or data repository 104 that encompasses a wide range of mathematical formulas, equations, and physical principles. These resources cover the breadth of the subject matter, from basic to advanced concepts. Also, personal data provided by the user on the user device during registration such as their names, age, date of birth, and other data such as their learning preferences, learning styles, goals, modes of interaction and their content viewing preferences (either video, audio, textual or image) may also be stored in a repository 104 in a form of historical data associated with the individual user.

The teaching and learning platform 102, is designed to provide a personalized and engaging learning experience to students. Its advanced AI algorithms work by constantly assessing each student's proficiency in a given subject. By analysing their responses, progress, and learning patterns in real time, the platform can generate unique video lectures and storytelling content that are tailored to each student's specific needs and preferences.

In an embodiment, the platform provides an ability to dynamically generate educational content ensures that each student receives a customized learning experience that is perfectly aligned with their current comprehension level and learning style. This not only improves their ability to learn and retain information but also helps foster a deeper love for learning, as students are presented with materials that they find engaging and relevant. The platform provides students with a vast library of educational content covering a wide range of academic topics and offers multiple versions of video lectures and storytelling content for each of them. These versions range from beginner to advanced levels, ensuring that students have access to materials that cater to their individual needs and learning requirements. In case a student finds an advanced-level video too difficult to comprehend, they can choose to watch a simpler version of the video or request an explanation from the platform. The platform is designed to provide explanations in layman's terms, ensuring that students have a better understanding of the subject matter. This adaptability feature of the platform ensures that students have access to content that precisely matches their current learning requirements. This can help students to develop a deeper and more effective understanding of the subject matter. The platform serves as an excellent tool for students to learn at their own pace and in a way that works best for them.

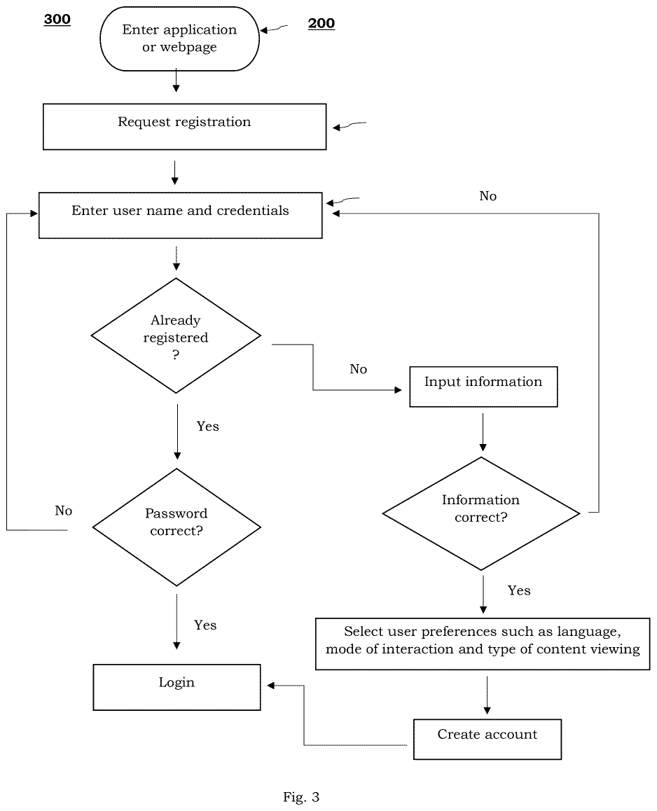

In FIG. 3, a method is described for registering a user on a teaching and learning platform. The process begins with step *** where the user accesses the platform's application or webpage through an interface on their device. They then click on the registration page and are prompted to authenticate their identity. Once the user has accessed the registration page, they are required to input their personal details such as their username or email ID, along with a password. The platform checks if the user has already registered, and if so, their password is matched with the one stored in the data repository which contains all personal and historical data related to each user. If the password is a match, the user is granted access to the platform. On the other hand, if the user has not yet registered, they are prompted to input their information and credentials to complete the registration process. The user's information is verified again to ensure its validity. After this process, the user can save their preferences, such as the format of their preferred content (video, text, image, audio, or figures), their preferred language of interaction, and the language they want to view the content in. Once the account is successfully created, the user will be logged in to the platform.

In one embodiment, the innovative educational platform is available to a wide range of users through a flexible subscription model. Tailored subscriptions are provided to meet the unique needs of different user categories, including personal use, single-profile users, multi-profile users for families, professional tutors, and educational institutions. The pricing model is designed to ensure affordability and scalability, enabling individuals and organizations to take advantage of the power of AI-driven education.

Additionally, the system has been meticulously designed to prioritize data privacy and ethical AI practices that aim to safeguard the security and integrity of student information. The system takes various measures to protect sensitive data, including data encryption, anonymization, strict access controls, and regular security audits.

In another embodiment, the system has been designed to capture user data continuously and in-depth. It is capable of gathering a wealth of information on cognitive skills such as learning capabilities, reasoning abilities, learning pace, and learning styles. Additionally, the system gathers data on user behavior, including alertness, attentiveness, focus, and interest. It also captures data on the emotional and motivational state of the user, their grades, educational background, interests, performance history, and progress level. The teaching and learning platform then uses this data to improve and update its content continuously. The system ensures that the content remains up-to-date with the latest knowledge and best practices across various subject areas. By doing so, it creates educational materials that are tailored specifically to each student, taking into account their individual strengths, weaknesses, and learning preferences. This approach ensures that the materials provided to each student are optimized for their unique learning needs, enabling them to learn more effectively and efficiently. The system constantly monitors and updates itself based on the data it captures, providing a personalized learning experience to each student.

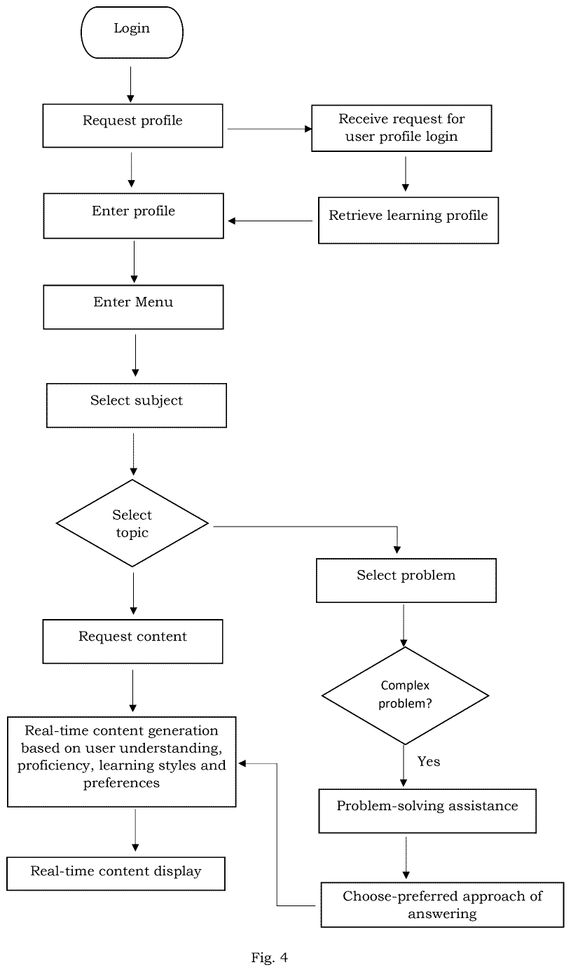

In another embodiment, upon a learner's registration, the teaching and learning educational platform performs an initial proficiency evaluation to determine the person's current level of expertise in the selected subject. This evaluation may include tests, quizzes, or self-assessment questionnaires. The platform continuously monitors and analyses various aspects of a student's interaction with the content. These aspects include the student's real-time responses to questions, their engagement with quizzes and interactive activities, their progress, which includes the topics they have covered and their overall progress, and their learning patterns, which include identifying recurring patterns in how a student learns, such as the areas where they excel or struggle, and how they approach problem-solving. The platform employs AI algorithms to assess a student's problem-solving preferences. It analyses the student's responses to previous questions, their performance in quizzes, and their interactions with content. This analysis identifies whether the student tends to favour mathematical equations or conceptual explanations when tackling problems. The platform assists students and allows them to choose their preferred problem-solving approach by determining if the student has a stronger inclination towards mathematical rigor and opt for the mathematical equation method as shown in FIG. 4. Alternatively, if they find concepts more intuitive, they can choose the conceptual physics approach. Let's consider a physics problem where a student needs to calculate the force applied to an object. If the student prefers a mathematical approach, the platform will provide the relevant formula, such as Newton's second law (F=ma), where ‘F’ represents force, ‘m’ is mass, and ‘a’ is acceleration. The educational platform will guide the student through the calculation step by step, prompting them to input values for mass and acceleration and then perform the calculation to find the force. The student may see equations, variables, and numerical values as they work through the problem. On the other hand, if the student prefers a conceptual physics approach, the platform will offer a different pathway. It may explain the concept of force in terms of interactions between objects without immediately introducing mathematical equations. The platform may use animations, diagrams, or real-world examples to illustrate how force operates in the context of the problem and the student can focus on understanding the concept and the principles behind it, without extensive mathematical calculations.

The educational platform is designed to learn from the choices made by the student and adjust its problem-solving assistance accordingly. If the student consistently chooses one approach over the other, the platform will prioritize that method in future problems. This adaptive learning process ensures that the student is able to tackle problems in a way that aligns with their unique understanding and preferences, thus enhancing their overall learning experience. In one of its embodiments, the platform offers a unique solution to complex problems. It allows students to select their preferred approach at each step based on their comprehension level. When faced with a complex problem, the platform provides multiple personalized options for students to choose from to solve the problem. At each step of the process, the options offered will differ based on the user's comprehension level. Users can change their approach, return to previous steps at any time, and receive explanations, reasonings, hints, and recommendations along their problem-solving journey.

The platform is an innovative educational solution that provides personalized learning experiences to students. It offers a wide range of subjects, including academic disciplines and professional skills development, with a focus on adaptive learning. The platform dynamically generates unique content that is tailored to individual student comprehension levels and learning preferences by adjusting the difficulty level according to the user's learning pace. This ensures that students can learn at their own pace and in a way that suits them best. One of the platform's key features is its ability to provide real-time adaptation of content and teaching methods and materials. This means that the platform can adjust its approach to teaching based on the student's performance and engagement level. The platform measures the engagement level of each user, such as attentive, focused, or distracted. If the platform determines that the user's engagement level is decreasing, it dynamically adapts the content according to the user's engagement level. This ensures that students remain engaged and motivated throughout their learning journey. An important aspect of the platform is its ability to interpret student feedback. During the teaching process, if a student terminates the learning session, the platform interprets this feedback as an indicator that the standard teaching approach may not align with the student's comprehension level or preferred learning style. In response to the student's feedback, the platform dynamically adjusts its teaching strategy. It starts the teaching process anew, but this time with a simplified and more accessible approach to the subject matter. This iterative process continues until the student reaches a point of comprehension. Importantly, the platform does not perceive or evaluate the student based on the number of terminations. Instead, it regards each termination as a valuable piece of feedback and utilizes this information to shape the learning experience precisely to the student's requirements. This ensures that students receive personalized attention and support, which can help them achieve their learning goals more effectively.

The platform offers a personalized feedback and guidance feature for users to receive support from teachers, mentors, and parents. If a user answers a question incorrectly, the learning system identifies the knowledge gap and provides a new problem of lower difficulty level. Along with the new problem, the user is also given recommendations and guidance to clear their doubts and misconceptions. After the user has successfully solved the easier problem, the learning system gradually increases the difficulty level of the problems until the user has gained a clear understanding of the concept.

FIG. 4 illustrates a problem-solving method and real-time generation of content based on user's understanding and learning style. To access the platform, the user must create an account and log in. After logging in, the user can request their profile. The educational platform will retrieve the profile and verify the credentials. Once the credentials are verified, the user can access their profile, as shown in step ***. In step ***, the user can select a subject they want to learn by entering the menu of the application or webpage. Step *** includes selecting the topic the user wants to learn and selecting the problem form that topic in step ***. In the next step ***, the platform determines if the problem is a complex problem and requires assistance in solving. A problem-solving assistance is provided to the learner in the form of hints, guidance and different ways to answer a problem. The user can choose their preferred approach from plurality of approaches for answering the problem. When solving a complex problem, the platform allows students to choose their preferred approach at each step and provides personalized options for students to choose from based on their comprehension level. For example, when answering a complex problem, the platform will provide multiple individualized options on how to solve the problem, and the student can choose any of the provided approaches at each step. The approach options will differ at each step, depending on the user's comprehension level. While solving a problem in multiple steps, the user can choose to return to the previous steps at any time and can change their approach. At each step of problem solving, students are provided with explanation, reasoning, hints and recommendations. Based on the approach selected by the user in step ***, the platform generates a real-time content using real-time responses of the users. It achieves this through a dynamic and adaptive approach to content delivery, characterized by personalized video lectures and storytelling modules.

In conclusion, the invention disclosed outlines an ambitious vision for a teaching and learning platform to provide education that has the potential to revolutionize the way students learn physics, mathematics, and a multitude of other subjects. By providing personalized, adaptable, and interactive content, this platform aims to empower students at all levels of education, fostering a lifelong love for learning and a deep understanding of complex subjects. Embodiments described above illustrate but do not limit the invention. It should also be understood that numerous modifications and variations are possible in accordance with the principles of the invention.

1. An adaptive teaching and learning system for personalized content delivery comprising:
a) a user interface module enabling users to register themselves and set their goals and preferences;
b) a proficiency assessment module for assessing the existing skills and knowledge;
c) a progress assessment module for continuous assessment and evaluating the performance;
d) a feedback and guidance module for offering real-time feedback with personalized guidance and support;
e) a content generator module and a problem-solving assistance module,
wherein the problem-solving assistance module provides assistance and enables students to choose their preferred approach to the given problem at each step, based on which the content generator module dynamically tailors and generate the content adapting to the unique comprehension levels, learning styles, real-time responses and progress of the users.

2. The teaching and learning platform as claimed in claim 1, wherein delivers flexible subscription model for personal use, single-profile users, multi-profile users/families, tutors, and educational institutions.

3. The teaching and learning platform as claimed in claim 1, wherein is compatible with various devices like laptops, desktops, VR environments, and holographic interfaces.

4. The teaching and learning platform as claimed in claim 1, wherein evaluates proficiency using tests, quizzes or self-assessment questionnaires.

5. The teaching and learning platform as claimed in claim 1, wherein provide assistance in solving a problem by the use of diagrams, animations, images, videos, storytelling or real-world examples.

6. The teaching and learning platform as claimed in claim 1, wherein is equipped with an extensive knowledge base that encompasses a wide range of mathematical formulas, equations, and physical principles, and user data.

7. A method for delivering a personalized and adaptive content in a teaching and learning platform comprising:
assessing comprehension level of the user;
generating unique content adapting to unique comprehension levels and learning styles,
wherein the content is generated based on real-time responses, progress and individual learning patterns;
adjusting the content dynamically in real-time based on user knowledge and performance;
providing feedback to offer personalized guidance and support;
offering assistance in solving complex problems;
wherein,
the users are provided the flexibility to choose their preferred approach in solving the problem and adapting the content based on the preferred approach and cognitive skills of the user.

8. The method as claimed in claim 7, wherein extends to an array of subjects, encompassing chemistry, English, biology, economics, finance, accounts, management, dance, history, civics, geography, music, and more.

9. The method as claimed in claim 7, wherein uses user's feedback, responses and terminations as an indicator and adjusts the preferred learning style.

10. The method as claimed in claim 7, wherein generates content in real-time based on user's proficiency, understanding, cognitive skills, engagement level, professional goals, interests, educational background, performance history, and individual assessment.

11. The method as claimed in claim 7, wherein involves real-time adaption and continuous upgradation of teaching methods and materials.

12. The method as claimed in claim 7, wherein safeguards sensitive information such as user data by using encryption and anonymization techniques, in compliance with the strictest data protection regulations.
